(19) United States
(12) Patent Application Publication
(10) Pub. No.: US 2026/0253189 A1
(43) Pub. Date: Aug. 27, 2026

(54) SYSTEM AND METHOD FOR HDR RECONSTRUCTION

(71) Applicant: MEDIATEK INC., Hsinchu City (TW)

(72) Inventors: Yen-Yu LIN, Hsinchu City (TW); Yo-Tin LIN, Hsinchu County (TW); Yu-Lun LIU, Hsinchu (TW); Hou-Ning HU, Hsinchu City (TW); Su-Kai CHEN, Hsinchu City (TW)

(21) Appl. No.: 19/529,430

(22) Filed: Feb. 4, 2026

Related U.S. Application Data
(60) Provisional application No. 63/757,904, filed on Feb. 13, 2025.

(51) Int. Cl. G06T 5/90; G06N 3/0475; G06T 5/50; G06T 5/77; G06T 7/50; G06V 10/25; G06V 10/60

(52) U.S. Cl. CPC G06T 5/90; G06N 3/0475; G06T 5/50; G06T 5/77; G06T 7/50; G06V 10/25; G06V 10/60; G06T 2207/20208; G06T 2207/20221

(57) ABSTRACT

A method for HDR reconstruction is provided. The method generates a plurality of baseline images with different exposure values (EVs) from an input image and identifies a target region. A generative model is utilized to perform a first inpainting process, and the results are merged into an initial HDR image. The initial HDR image is then mapped back into aligned images, where a compensating step is performed based on the baseline images to ensure the synthesized content satisfies a luminance constraint. A second inpainting process is performed to generate refined images from the compensated images, which are merged into a target HDR image.

### CROSS REFERENCE TO RELATED APPLICATIONS

This application claims the benefit of U.S. provisional application No. 63/757,904, filed Feb. 13, 2025, the entirety of which is incorporated by reference herein.

### TECHNICAL FIELD

The present disclosure relates to computer vision, and more particularly, to a method and system for HDR reconstruction.

### BACKGROUND

Digital images are typically captured and stored in Low Dynamic Range (LDR) formats, which offer a limited range of luminance levels. In contrast, High Dynamic Range (HDR) images provide a much broader spectrum of brightness and contrast, more closely approximating the visual perception of the human eye. Transforming LDR images into HDR content is a critical process for enhancing image quality, as it allows for the recovery of details in both dark shadows and bright highlights that would otherwise be lost. By expanding the dynamic range, HDR reconstruction enables a more immersive and realistic visual experience across various display technologies and imaging applications.

However, HDR reconstruction from a single image presents significant technical challenges, particularly regarding the restoration of lost information in saturated regions. While various reconstruction approaches exist, maintaining a high degree of robustness across diverse environmental conditions without extensive scene-specific optimization remains a primary objective. Furthermore, ensuring both photometric and structural consistency throughout the reconstruction process is essential for achieving a seamless and natural-looking HDR output. Many current frameworks face limitations in providing the precise control mechanisms required to ensure that synthesized content is consistently aligned with the physical characteristics of the original scene.

Therefore, an improved HDR reconstruction system and method is needed to address the above issues.

### BRIEF SUMMARY

An embodiment of the present disclosure provides a method for HDR reconstruction. The method includes: obtaining an input image; generating a plurality of baseline images associated with different exposure values (EVs) based on the input image; identifying a target region in the plurality of baseline images; performing a first inpainting process on the target region of the plurality of baseline images using a generative model to generate a plurality of inpainted images; merging the plurality of inpainted images into an HDR image based on a response function; mapping the HDR image into a plurality of aligned images based on the response function; performing a compensating step to compensate pixel values of the plurality of aligned images based on the plurality of baseline images, to generate a plurality of compensated images that satisfy a luminance constraint; performing a second inpainting process on the target region of the plurality of compensated images using the generative model, to generate a plurality of refined images; and merging the plurality of refined images into a target HDR image.

In some embodiments, the compensating step further comprises determining a luminance difference between the plurality of aligned images and the plurality of baseline images, and compensating the pixel values based on the luminance difference.

In some embodiments, the method further comprises performing at least one iterative refinement prior to the second inpainting process, wherein the iterative refinement involves generating an updated plurality of inpainted images, an updated HDR image, and an updated plurality of aligned images to calculate an updated luminance difference. The method may further comprise applying a compensation strength that is varied across different performances of the compensating step.

In some embodiments, identifying the target region involves generating an over-exposed area mask and a depth map. The over-exposed area mask is updated based on the updated luminance difference to obtain an updated mask by excluding regions in which the luminance constraint is satisfied, for guiding the subsequent inpainting processes.

In some embodiments, the generative model is a diffusion-based model, and the method implements a noise scheduling strategy where a target noise level is configured to decrease across successive inpainting processes. Furthermore, at least one of the inpainting processes includes conditioning the generative model on prompt information to generate image content for the target region.

In some embodiments, the luminance constraint requires that luminance values of synthesized content are not lower than luminance values of corresponding pixels in the baseline images.

Another embodiment of the present disclosure provides a system for HDR reconstruction, comprising a storage unit and a processing unit coupled thereto. The processing unit is configured to execute the aforementioned steps, including the multi-stage generative inpainting and the photometric compensation mechanisms, to achieve a visually natural and photometrically plausible high dynamic range result.

In some embodiments, the processing unit is configured to perform the compensating step by determining a luminance difference between the plurality of aligned images and the plurality of baseline images, and adjusting pixel values within the target region based on the luminance difference.

In some embodiments, the processing unit is further configured to perform at least one iterative refinement, wherein the processing unit progressively reduces a luminance residual by iteratively updating the inpainted images, the HDR image, and the aligned images before the second inpainting process.

In some embodiments, the processing unit is configured to generate and update an over-exposed area mask and a depth map to identify the target region, wherein the over-exposed area mask is dynamically updated based on the luminance difference to exclude regions that already satisfy the luminance constraint, thereby focusing subsequent inpainting processes on remaining unsatisfied areas.

In some embodiments, the processing unit is configured to modulate the compensation mechanisms by applying a compensation strength that varies across different iterations or performances of the compensating step to ensure stable convergence.

In some embodiments, the processing unit utilizes a diffusion-based model as the generative model and implements a noise scheduling strategy, wherein a target noise level for adding noise to the images is configured to decrease across successive inpainting processes to balance generative creativity and structural consistency.

In some embodiments, the processing unit is configured to enforce the luminance constraint such that luminance values of the reconstructed content are not lower than luminance values of corresponding pixels in the baseline images, ensuring physical consistency with the original scene radiance.

In some embodiments, the processing unit is further configured to condition the generative model on prompt information, such as semantic descriptors, to guide the synthesis of textures and structures that are contextually and photometrically appropriate for the target region.

In summary, embodiments of the present disclosure provide a generative-based framework for high dynamic range (HDR) reconstruction of over-exposed regions. The disclosed method and system utilize generative priors to synthesize plausible image content while ensuring exposure consistency throughout the reconstruction process. By integrating iterative refinement with luminance compensation mechanisms, embodiments of the present disclosure enable the production of high-quality HDR outputs where synthesized regions are seamlessly blended with original scene data. This framework allows for the restoration of information in regions affected by sensor saturation, providing a versatile solution that can be adapted to various imaging contexts.

### BRIEF DESCRIPTION OF THE DRAWINGS

The present disclosure can be more fully understood by reading the subsequent detailed description and examples with references made to the accompanying drawings, wherein:

FIG. 1 a system for HDR reconstruction, according to an embodiment of the present disclosure;

FIG. 2A illustrates a flow diagram of a method for HDR reconstruction, according to an embodiment of the present disclosure;

FIG. 2B shows a dataflow of the image pre-processing method, according to an embodiment of the present disclosure;

FIG. 3A illustrates an unreasonable luminance mapping curve containing a distorted luminance segment;

FIG. 3B illustrates an effective luminance curve according to an embodiment of the present disclosure;

FIG. 4A presents an illustrative example of the input LDR image;

FIG. 4B presents an example of the HDR image generated after the initial inpainting and merging steps according to an embodiment of the present disclosure;

FIG. 4C depicts a target HDR image;

FIG. 5 shows a data flow illustrating an initial performance of the compensating step;

FIG. 6 shows at least one iterative refinement performed prior to the second inpainting process, according to an embodiment of the present disclosure; and

FIG. 7 shows a data flow illustrating the generation of an updated mask according to an embodiment of the present disclosure.

### DETAILED DESCRIPTION

The following description is made for the purpose of illustrating the general principles of the disclosure and should not be taken in a limiting sense. The scope of the disclosure is best determined by reference to the appended claims.

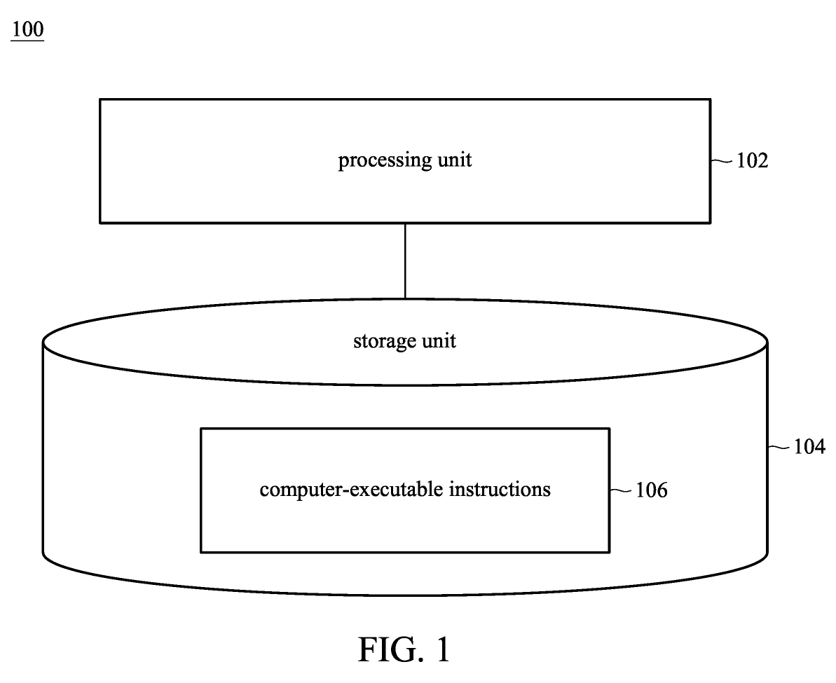

FIG. 1 shows a system 100 for HDR reconstruction, according to an embodiment of the present disclosure. As show in FIG. 1, the system 100 may include a processing unit 102 and a storage unit 104. Computer-executable instructions 106 may be stored in the storage unit 104. The processing unit 102 may be connected to the storage unit 104 via wired or wireless connections to execute the computer-executable instructions 106 stored in the storage unit 104.

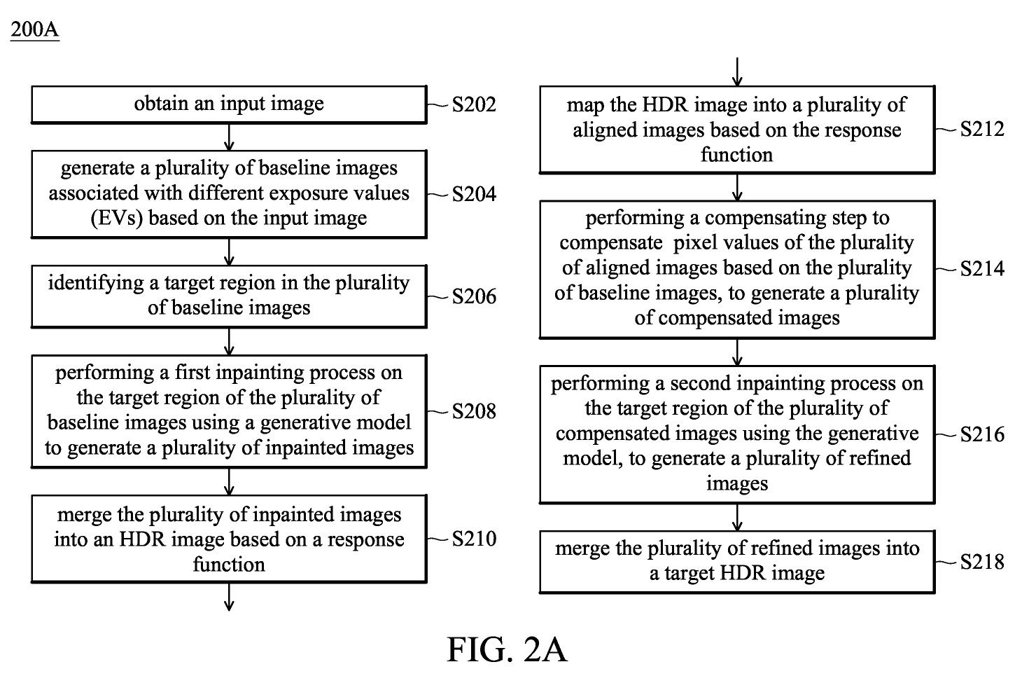

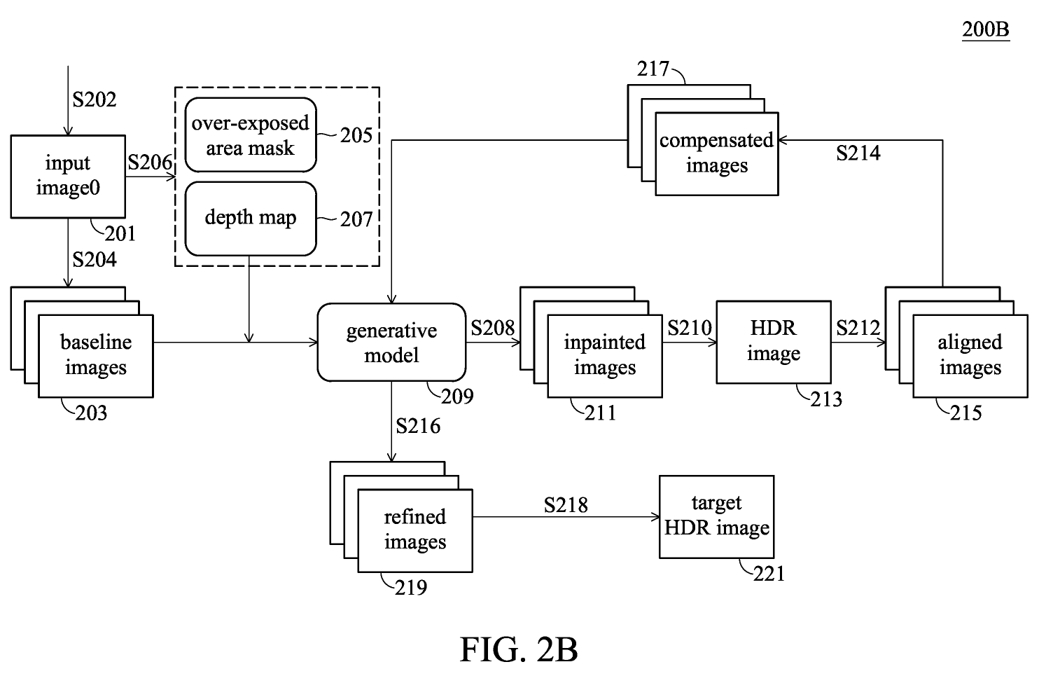

The processing unit 102 may be implemented as one or more processors, such as a central processing unit (CPU), a graphics processing unit (GPU), an application-specific integrated circuit (ASIC), or a field-programmable gate array (FPGA), but the present disclosure is not limited thereto. In the embodiments of the present disclosure, the processing unit 102 may execute the computer-executable instructions 106 stored in the storage unit 104 to perform steps illustrated in FIG. 2A.

The storage unit 104 may be configured to store data, programs, or intermediate processing results (e.g., the plurality of baseline images, the over-exposed area mask, or the depth map). The storage unit 104 may include any type of computer-readable storage medium, such as a hard disk drive (HDD), a solid-state drive (SSD), a memory card, flash memory, or optical storage media. According to an embodiment of the present disclosure, the storage unit 104 may include volatile memory (e.g., DRAM) or non-volatile memory (e.g., NAND flash), and may reside locally on the system 100 or be accessible via a remote server or cloud storage, but the present disclosure is not limited thereto.

The computer-executable instructions 106 may include a set of instructions, modules, or scripts stored in the storage unit 104 and executed by the processing unit 102. The computer-executable instructions 106 may be implemented in any suitable programming language, such as Python, C, C++, Java, or MATLAB, but the present disclosure is not limited thereto. According to an embodiment of the present disclosure, the computer-executable instructions 106 may be developed using a combination of high-level and low-level languages, or may utilize existing libraries and frameworks for image processing or machine learning. The HDR reconstruction method (or image pre-processing method) implemented by the computer-executable instructions 106 will be described in detail below with reference to FIGS. 2A and 2B.

FIG. 2A illustrates a flow diagram of method 200A for HDR reconstruction, according to an embodiment of the present disclosure. FIG. 2B shows a dataflow 200B of the method 200A, according to an embodiment of the present disclosure. For a better understanding of the present disclosure, FIGS. 2A and 2B may be referred to together. As shown in FIG. 2A, method 200A includes steps S202-S218. These steps will be described in detail below.

Method 200A starts in step S202. In step S202, the processing unit 102 obtains an input image 201. The input image 201 may be obtained from an image sensor, a local storage, or a remote server via a network interface. According to an embodiment of the present disclosure, obtaining the input image 201 may further include retrieving associated metadata, such as aperture or ISO settings, to facilitate subsequent exposure simulations. The input image 201 may be provided in various formats, including raw or compressed formats, and may be buffered within the storage unit 104 for HDR reconstruction, but the present disclosure is not limited thereto.

In step S204, the processing unit 102 generates a plurality of baseline images 203 associated with different exposure values (EVs) based on the input image 201. According to an embodiment of the present disclosure, the processing unit 102 may utilize a learning-based model (e.g., a Deep Neural Network) or a single-image HDR reconstruction algorithm to generate the plurality of baseline images 203 from the single input image 201. Specifically, since a true Camera Response Function (CRF) and actual multi-exposure bracketed images are typically unavailable, the learning-based model is configured to simulate or hallucinate a sequence of images representing varying exposure levels based on the input image 201. These generated baseline images 203 serve as a pseudo-exposure stack, which can be subsequently used to estimate the CRF and synthesize an HDR image (e.g., using Debevec’s method), but the present disclosure is not limited thereto.

In some embodiments, the generation of the baseline images 203 involves utilizing pre-trained HDR reconstruction models or deep learning-based inverse tone mapping algorithms. Instead of merely performing linear scaling which may fail to recover information in saturated regions, the processing unit 102 employs these algorithms to infer or predict the content of the baseline images 203 at various exposure levels. These methods are capable of synthesizing plausible details in over-exposed or under-exposed areas by learning from large-scale HDR datasets, thereby producing a high-quality stack of baseline images 203 that simulates a physical multi-exposure bracket, even without prior knowledge of the actual camera response function. The plurality of baseline images 203 typically covers a predefined EV range (e.g., from -1EV to -3EV) to ensure sufficient dynamic range coverage. The resulting plurality of baseline images 203 is stored in the storage unit 104 to serve as a reference for subsequent luminance compensation and refinement stages.

In step S206, the processing unit 102 identifying a target region in the plurality of baseline images 203. The target region generally refers to areas in the images that require reconstruction, restoration, or enhancement, such as regions with lost details due to saturation or noise. In one embodiment, identifying the target region includes generating an over-exposed area mask 205 and a depth map 207, but the present disclosure is not limited thereto. In other embodiments, the target region may be identified based on under-exposed (shadow) areas, noise-corrupted regions, user-specified regions of interest (ROI), or regions detected by an object detection algorithm (e.g., removing or fixing specific objects). Furthermore, the identification may be performed using simple luminance thresholding, histogram analysis, or more complex semantic segmentation networks, depending on the specific application requirements. In certain embodiments, the over-exposed area mask 205 is generated by applying a luminance threshold to the input image 201 to identify saturated pixels, or is generated based on a user-provided indication. For instance, pixels with intensity values exceeding a predefined threshold (e.g., 250 in an 8-bit scale) are flagged to form the over-exposed area mask 205. In other embodiments, the over-exposed area mask may be generated based on a user-provided indication. The user-provided indication may be obtained through a user interface of an application, where a user can manually define or refine a region of interest. For example, the user may use a touch input or a pointing device to hand-draw a boundary or brush over specific areas on the input image 201 to designate them as over-exposed or requiring reconstruction. The over-exposed area mask 205 indicates over-exposed areas in the input image 201 where original scene information is lost due to sensor saturation.

Specifically, the over-exposed area mask 205 functions as a binary or soft-weighted guidance map that constrains the generative model 209 to synthesize new image content only within the flagged saturated regions while preserving original details in non-saturated regions. By mapping this mask across the plurality of baseline images 203, the processing unit 102 ensures that content reconstruction is consistently applied to corresponding physical locations regardless of varying exposure values (EVs). This defines the precise target regions for subsequent content reconstruction and luminance compensation across the entire plurality, but the present disclosure is not limited thereto.

Simultaneously, the depth map 207 is generated based on the input image 201 utilizing a depth estimation algorithm, such as a monocular depth estimation network, to provide spatial structural guidance for content synthesis. The depth map 207 represents relative distances of objects within the scene, which facilitates maintaining geometric consistency during reconstruction. According to an embodiment of the present disclosure, the processing unit 102 utilizes the depth map 207 in conjunction with the over-exposed area mask 205 to ensure that texture generated within the defined regions aligns with the spatial context and geometric structure of surrounding non-saturated regions, but the present disclosure is not limited thereto.

In step S208, the processing unit 102 performing a first inpainting process on the target region of the plurality of baseline images 203 using a generative model 209 to generate a plurality of inpainted images 211. In one embodiment, the processing unit 102 inpaints the over-exposed areas of the plurality of baseline images 203 using a generative model 209 based on the over-exposed area mask 205 and the depth map 207 to generate a plurality of inpainted images 211. According to an embodiment of the present disclosure, the generative model 209 may be implemented as a diffusion-based generative model that performs a denoising process conditioned on spatial priors. Specifically, the processing unit 102 utilizes the over-exposed area mask 205 to define target regions for content synthesis while keeping non-saturated pixels intact.

Simultaneously, the depth map 207 is injected into the generative model 209 as a structural constraint (e.g., via a ControlNet or a similar conditional architecture) to ensure that the synthesized image content aligns with the geometric layout of the scene. In certain embodiments, the processing unit 102 may process each image in the plurality of baseline images 203 individually or jointly to ensure visual consistency across different exposure levels. The generative model 209 effectively reconstructs missing textures and semantic details within the saturated regions, thereby producing the plurality of inpainted images 211 that serves as the foundation for subsequent HDR merging, but the present disclosure is not limited thereto.

In step S210, the processing unit 102 merges the plurality of inpainted images 211 into an HDR image 213 based on a response function. The term "response function" as used herein broadly refers to any mapping relationship, curve, or function that describes the conversion between pixel values (e.g., digital counts) and physical scene radiance or luminance. This includes, but is not limited to, a Camera Response Function (CRF), an Inverse Camera Response Function (ICRF), a Gamma curve, a linear response, or a learnable mapping network derived from deep learning models. For the sake of brevity and clarity, the following embodiments may primarily use the ICRF as a representative example of the response function, but the present disclosure is not limited thereto. Specifically, the response function utilized in this step can be a known CRF associated with the capture device of the input image 201, an estimated CRF calculated from the plurality of baseline images 203 (e.g., using Debevec’s method), or a manually set mathematical curve such as a standard Gamma 2.2 curve. Any function capable of mapping the inpainted images 211 into a linear or high-dynamic-range domain suitable for merging falls within the scope of the present disclosure. It should be understood that references to operating "based on the response function" encompass utilizing either its forward form or its inverse form as required by the context of the processing step. According to an embodiment of the present disclosure, the processing unit 102 utilizes the ICRF to transform each image in the plurality of inpainted images 211 from a non-linear color space into a linearized luminance domain. During the merging process, the processing unit 102 may apply a weighting function to each pixel based on its proximity to the optimal exposure range of the camera sensor, thereby maximizing the signal-to-noise ratio in the resulting HDR image 213. This merging operation integrates the synthesized content from over-exposed regions with the original details from properly exposed regions.

In step S212, the processing unit 102 maps (or remaps) the HDR image 213 into a plurality of aligned images 215 based on the response function (e.g., applying the inverse of the ICRF, i.e., the forward CRF). The primary purpose of this mapping step is to convert the reconstructed HDR content back into the same domain (e.g., LDR domain or digital count domain) as the plurality of baseline images 203. Since the subsequent compensation step (S214) relies on calculating a difference or residual between the reconstructed images and the original baseline images 203, both sets of images must be in a compatible format and exposure level. By mapping the HDR image 213 into the plurality of aligned images 215—which correspond to the specific exposure values of the baseline images 203—the processing unit 102 enables a direct, pixel-wise comparison. These images 215 are referred to as "aligned" because they are geometrically perfectly aligned with each other (originating from the same HDR image) and radiometrically aligned with the target exposure levels of the baseline images 203.

In step S214, the processing unit 102 compensates pixel values of the plurality of aligned images 215 based on the plurality of baseline images 203 to generate a plurality of compensated images 217. In an embodiment, the plurality of compensated images 217 is configured to satisfy a luminance constraint associated with the over-exposed areas of the plurality of baseline images 203. In an embodiment, the luminance constraint ensures that the luminance values of the reconstructed content are not lower than a lower-bound luminance of the saturated regions in the plurality of baseline images 203.

For example, if the generative model 209 synthesizes content that is darker than the clipping threshold of the original sensor, the processing unit 102 applies an additive or multiplicative compensation factor (or adjusting factor) to compensate (or adjust) those pixels upward until the luminance constraint is met. This adjustment ensures that the generated content maintains physical consistency with the high-intensity nature of the original over-exposed scene. According to an embodiment of the present disclosure, the compensation (or adjusting) step is performed in a non-linear domain, specifically within a luminance-chrominance color space (e.g., YUV, YCbCr, or Lab). To perform this, the processing unit 102 first converts both the plurality of aligned images 215 and the plurality of baseline images 203 from a standard RGB format into the YUV format (or another format separating luminance from chrominance). The pixel-wise adjustment is then applied primarily to the luminance channel (Y channel) of the plurality of aligned images 215. Operating in the YUV domain allows the method to correct brightness discrepancies effectively without inadvertently altering color tones or saturation, which might occur if the adjustment were performed directly in the RGB space. After the luminance values are compensated, the images are converted back to the RGB format to form the plurality of compensated images 217. However, the present disclosure is not limited thereto, and the compensation may be performed in other color spaces or domains depending on the specific implementation.

In step S216, the processing unit 102 performing a second inpainting process on the target region of the plurality of compensated images 217 using the generative model 209 to generate a plurality of refined images 219. According to an embodiment of the present disclosure, this second inpainting stage refines visual textures and eliminates potential artifacts introduced during the luminance compensation, such as chromatic aberrations or unnatural boundary transitions between the compensated pixels and the surrounding regions. Specifically, the processing unit 102 utilizes the generative model 209 to harmonize the newly adjusted luminance values with the global context of the scene, ensuring that fine details (e.g., surface textures or specular highlights) are coherently integrated without losing the brightness levels established in the previous compensation step.

In step S218, the processing unit 102 merges the plurality of refined images 219 into a target HDR image 221. During this merging process, the processing unit 102 integrates the high-quality textures from the plurality of refined images 219 to produce a high dynamic range output with natural-looking content in previously over-exposed regions. Compared to the HDR image 213 generated in step S210, target HDR image the target HDR image 221 exhibits significantly improved photometric accuracy and high-fidelity visual details that are more consistent with the original high-intensity lighting conditions of the scene. Specifically, while the HDR image 213 may contain synthesized regions that appear unnaturally dim or exhibit exposure misalignments due to a lack of initial luminance constraints, the target HDR image 221 eliminates such artifacts through the iterative compensation and refinement process. This results in an exposure-aligned reconstruction where the synthesized content seamlessly integrates with the surrounding scene radiance, but the present disclosure is not limited thereto.

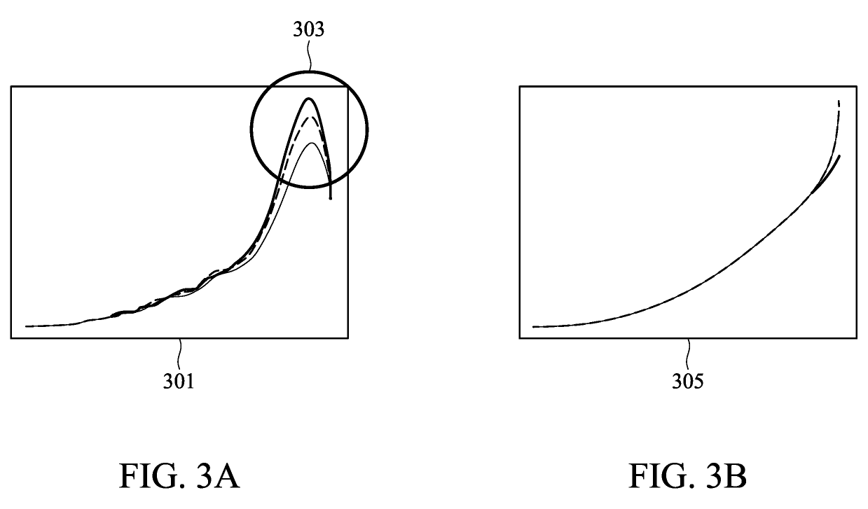

Referring to FIGS. 3A and 3B, the relationship between inpainted pixel values and the inverse camera response function (ICRF) estimation is further described. FIG. 3A illustrates an unreasonable luminance mapping curve 301 containing a distorted luminance segment 303, while FIG. 3B illustrates an effective luminance curve 305 according to an embodiment of the present disclosure. Based on the visual representation, the effective luminance curve 305 in FIG. 3B exhibits a strictly increasing trend, maintaining a monotonic relationship that aligns with the physical principles of radiance mapping. In contrast, the unreasonable luminance mapping curve 301 in FIG. 3A includes the distorted luminance segment 303, which manifests as a non-monotonic profile characterized by an initial increase followed by a subsequent decrease in luminance values. Such a phenomenon indicates a violation of physical consistency, where synthesized intensities in saturated regions are incorrectly generated below the required luminance lower bound.

According to an embodiment of the present disclosure, luminance compensation in step S214 is performed to prevent the occurrence of the distorted luminance segment 303. In conventional generative inpainting, a model may synthesize intensities that fall below the saturation threshold of the sensor. As depicted in FIG. 3A, the non-monotonic trend of the distorted luminance segment 303, specifically the segment that decreases after an initial rise, deviates from the expected physical radiance where pixel intensity should scale proportionally with scene exposure. This deviation leads to an incorrect and unstable ICRF, which frequently results in visual artifacts such as exposure misalignment or unnatural darkening in the merged HDR output.

To address this issue, a luminance constraint is enforced to generate the effective luminance curve 305 shown in FIG. 3B. By ensuring that the luminance values of the reconstructed content are not lower than the lower bound of corresponding pixels in the plurality of baseline images 203, the processing unit 102 maintains bounded intensities that are physically consistent with the original scene. This ensures a proper and stable ICRF, resulting in an exposure-aligned reconstruction that matches the input image 201, but the present disclosure is not limited thereto.

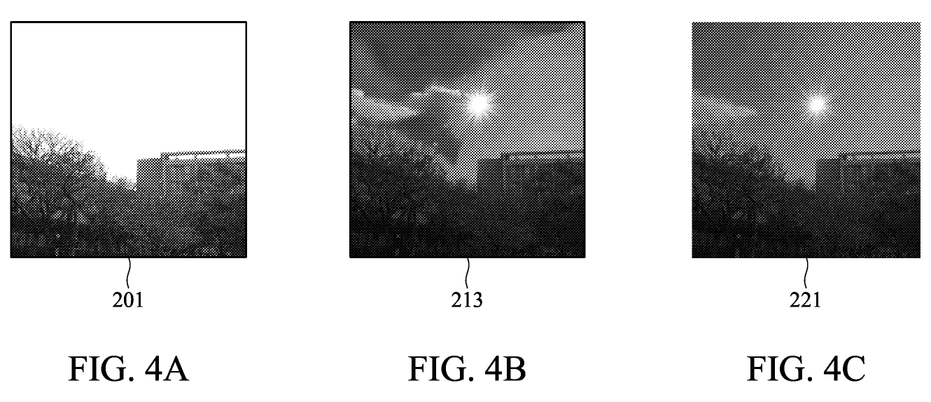

Referring to FIG. 4A, an illustrative example of the input image 201 is presented. As shown by FIG. 4A, the input image 201 typically exhibits a limited dynamic range, where bright regions (e.g., direct sunlight, light sources, or reflections) are severely over-exposed, appearing as saturated white areas with significant loss of detail. Conversely, dark regions may be underexposed, obscuring shadow details. This input image 201 serves as the initial data for the HDR reconstruction method described herein.

FIG. 4B presents an example of the HDR image 213 generated after the initial inpainting step 208 and merging step 210. Although the HDR image 213 attempts to reconstruct high dynamic range content, the reconstructed result is obtained without enforcing a luminance constraint relative to the input image 201. As a result, the generative inpainting process may introduce visually plausible yet physically inconsistent image content, particularly in regions corresponding to over-exposed areas. For example, the reconstructed sky region in the HDR image 213 may exhibit intensified highlights or altered illumination patterns that are inconsistent with the original lighting conditions captured in the input image 201.

In this example, the HDR image 213 illustrates a scenario in which an unconstrained diffusion model prioritizes semantic plausibility and visual richness during content generation, while insufficiently preserving exposure consistency with respect to the baseline luminance distribution of the input image 201. Consequently, although the HDR image 213 successfully depicts semantically coherent structures and textures, the reconstructed luminance values may deviate from a physically reasonable exposure relationship.

FIG. 4C depicts a target HDR image 221, which is the result of the intensity compensation and secondary inpainting processes. Compared to the HDR image 213 in FIG. 4B, the target HDR image 221 demonstrates an improved exposure-aligned reconstruction that more accurately reflects the lighting characteristics of the input image 201. In particular, luminance values in the over-exposed regions are compensated prior to the secondary inpainting step, such that the generated image content remains consistent with a lower-bound luminance defined by the baseline exposure.

In this example, the target HDR image 221 exhibits visually coherent highlight structures and illumination gradients that align with the physical lighting cues present in the input image 201. By constraining the diffusion-based generation process with respect to compensated luminance values, the secondary inpainting step is guided to produce content that is not only semantically reasonable but also exposure-consistent, thereby avoiding exaggerated or implausible lighting artifacts observed in the HDR image 213.

The comparison between the target HDR image 221 and the HDR image 213 showcases that, by enforcing the luminance constraint, the processing unit 102 is capable of regulating the generative behavior of the diffusion model to maintain physically meaningful exposure relationships across reconstructed regions. Accordingly, the disclosed HDR reconstruction method effectively balances the creative capacity of generative inpainting with luminance consistency, resulting in a refined HDR image that is both visually realistic and faithful to the original scene illumination.

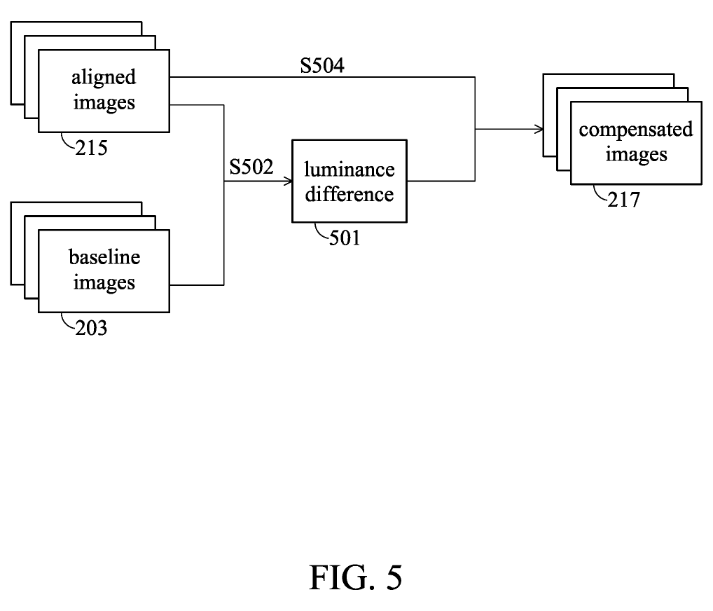

Referring to FIG. 5, FIG. 5 shows a data flow illustrating an initial performance of the compensating step S214. In some embodiments, the initial performance of the compensating step S214 includes sub-step S502 for determining a luminance difference 501 between the plurality of aligned images 215 and the plurality of baseline images 203. According to an embodiment of the present disclosure, the luminance difference 501 represents a pixel-wise discrepancy where synthesized intensities in the plurality of aligned images 215 fail to meet the minimum physical luminance required by corresponding saturated regions in the plurality of baseline images 203.

Upon determining the luminance difference 501, the compensating step S214 further includes sub-step S504, wherein the processing unit 102 adjusts the luminance values of the plurality of aligned images 215 based on the luminance difference 501 to generate the plurality of compensated images 217. In certain embodiments, this adjustment involves applying an additive offset or a scaling factor to pixels within the over-exposed areas, thereby shifting luminance levels of the pixels to be at least equal to or greater than the lower-bound luminance of the original over-exposed regions. This initial compensation ensures that exposure characteristics of the inpainted content are aligned with the global lighting of the scene before further refinement, but the present disclosure is not limited thereto.

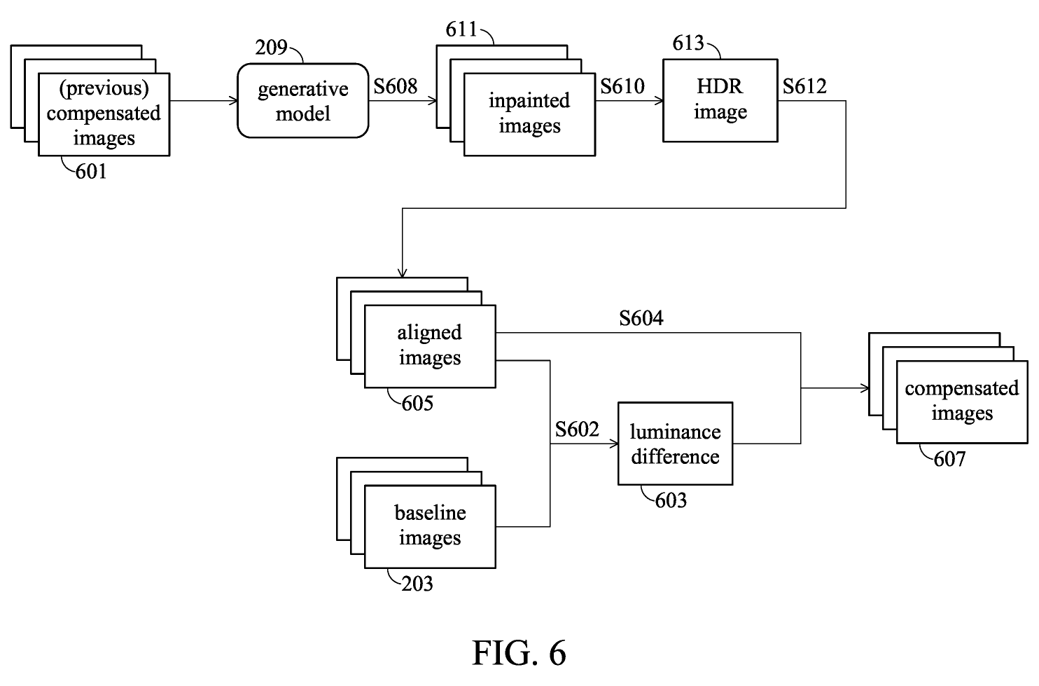

Referring to FIG. 6, FIG. 6 shows at least one iterative refinement performed prior to the second inpainting process (step S216), according to an embodiment of the present disclosure. As shown in FIG. 6, the iterative refinement includes performing an inpainting process on the target region of the plurality of compensated images 601, which is previously generated in the previous iteration of the inpaiting and compensation process, using the generative model 209 to generate an updated plurality of inpainted images 611 (step S608). Subsequently, the processing unit 102 merges the updated plurality of inpainted images 611 into an updated HDR image 613 based on the response function (step S610).

Furthermore, the iterative refinement includes mapping the updated HDR image 613 into an updated plurality of aligned images 605 based on the response function (step S612). This mapping process converts the high-dynamic-range information back into a format that allows for precise luminance verification against the original scene data. In some embodiments, the iterative refinement further includes calculating an updated luminance difference 603 (also referred to as a luminance residual) between the updated plurality of aligned images 605 and the plurality of baseline images 203, as shown in step S602. The updated luminance difference 603 identifies intensity differences that still exist after a previous compensation attempt.

Upon determining the updated luminance difference 603, the iterative refinement further includes generating an updated plurality of compensated images 607 by compensating (or adjusting) the pixel values of the updated plurality of aligned images 605 based on the updated luminance difference 603, as shown in step S604. By incorporating the updated luminance difference 603 into the updated plurality of aligned images 605, the processing unit 102 progressively refines the exposure levels of the inpainted regions. This iterative approach ensures that reconstructed pixels in the updated plurality of compensated images 607 are photometrically aligned with the high-intensity characteristics of the original saturated areas.

In some embodiments, compensating the pixel values of the updated plurality of aligned images 605 includes applying a compensation strength that is varied across different performances of the compensating step. Specifically, the processing unit 102 may dynamically modulate the magnitude of the adjustment based on the iteration count or the magnitude of the updated luminance difference 603. According to an embodiment of the present disclosure, the compensation strength is utilized as a scaling factor applied to the updated luminance difference 603 before the updated luminance difference 603 is incorporated into the updated plurality of aligned images 605.

For instance, the processing unit 102 may use a higher compensation strength during an initial performance of the compensating step to rapidly bridge the gap between the synthesized content and the required luminance lower bound. In subsequent performances, the processing unit 102 may gradually decrease the compensation strength to prevent overshooting or to fine-tune intensity levels, thereby ensuring a stable convergence toward the optimal photometric state..

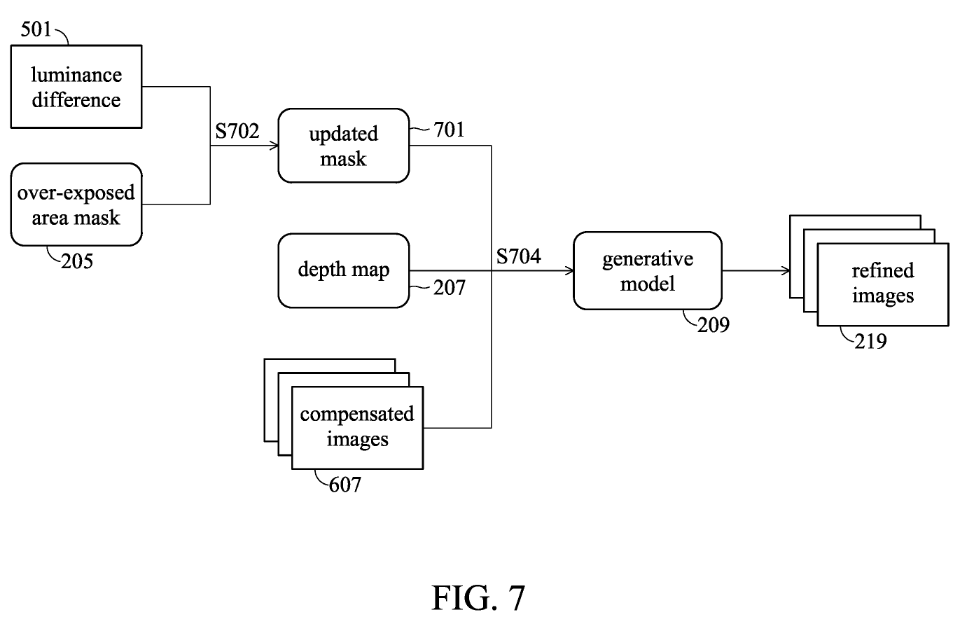

Referring to FIG. 7, FIG. 7 shows a data flow illustrating the generation and use of an updated mask 701 according to an embodiment of the present disclosure. To enhance the efficiency and precision of the refinement process, the method further includes sub-step S702, wherein the processing unit 102 updates the over-exposed area mask 205 based on the luminance difference 501 to obtain the updated mask 701.

Specifically, in sub-step S702, the processing unit 102 analyzes the luminance difference 501 to identify which pixels within the original over-exposed areas have already reached or exceeded the required luminance lower bound after the compensating step. This analysis enables the method to distinguish between regions that require further intensity adjustment and regions that already satisfy the physical constraints of the scene.

Subsequently, the method includes sub-step S704, wherein the inpainting of the over-exposed areas of the plurality of compensated images 607 is performed based on the depth map 207 and the updated mask 701. By utilizing the updated mask 701, the generative model 209 can focus its computational resources on the specific regions that require further visual refinement. This ensures that the resulting plurality of refined images 219 is both photometrically accurate and visually coherent with the surrounding scene, but the present disclosure is not limited thereto.

In some embodiments, the over-exposed area mask 205 is updated based on the luminance difference 501 to exclude regions in which the luminance constraint associated with the over-exposed areas is satisfied. Specifically, the processing unit 102 performs a pixel-wise evaluation of the luminance difference 501 to determine the sufficiency of the compensation. According to an embodiment of the present disclosure, for each pixel location within the over-exposed areas, if the processing unit 102 determines that the luminance value in the plurality of compensated images 217 has reached or exceeded a luminance lower bound defined by the plurality of baseline images 203, the luminance constraint is deemed satisfied for said pixel location.

Consequently, the processing unit 102 modifies the over-exposed area mask 205 by removing the flags or setting the values to zero for the pixel locations that satisfy the luminance constraint, thereby obtaining the updated mask 701. This dynamic update mechanism ensures that the subsequent inpainting stage (e.g., step S216) only processes the remaining regions that still fall below the required physical intensity levels. By excluding the satisfied regions from the updated mask 701, the processing unit 102 prevents the generative model 209 from redundantly modifying areas that already possess physically plausible luminance, which effectively preserves the photometric integrity of the reconstruction, but the present disclosure is not limited thereto.

In some embodiments, merging the plurality of inpainted images 211 into the HDR image 213 is performed using Debevec’s method based on the inverse camera response function (ICRF). Specifically, the processing unit 102 utilizes the ICRF to map the pixel intensity values of each image in the plurality of inpainted images 211 into a linearized radiance space. According to an embodiment of the present disclosure, the processing unit 102 calculates a weighted average of the linearized radiance values across the plurality, where the weights are determined by a hat-shaped weighting function that prioritizes pixel values in the middle of the camera's dynamic range.

By using Debevec’s method, the processing unit 102 effectively combines the simulated exposure information from the plurality of inpainted images 211 while minimizing the influence of noise and quantization errors. This process ensures that the synthesized details in the over-exposed regions are accurately integrated with the properly exposed background content in a unified high-bit-depth radiance map. The resulting HDR image 213 provides a robust foundation for subsequent remapping and refinement operations, thereby ensuring the final output achieves high photometric fidelity, but the present disclosure is not limited thereto.

In some embodiments, the luminance constraint requires that, during the compensating step (e.g., step S214 or a subsequent iteration), the luminance values of the plurality of aligned images 215 are not lower than the luminance values of corresponding pixels in the plurality of baseline images 203. Specifically, the processing unit 102 is configured to perform a pixel-wise comparison between the synthesized content and the original saturated content across the exposure levels of the plurality of baseline images 203. According to an embodiment of the present disclosure, for each pixel location (x, y) within the regions identified by the over-exposed area mask 205, the processing unit 102 verifies whether the intensity in the plurality of aligned images 215 has reached the saturation threshold or the specific baseline intensity captured in the plurality of baseline images 203.

This luminance constraint serves as a physical boundary condition for the generative model 209. Since the plurality of baseline images 203 represents the minimum actual light intensity received by the sensor (where pixels are clipped at a lower bound of the actual scene radiance), any reconstructed content that is darker than these baseline pixels is deemed photometrically incorrect. By enforcing that the luminance values are not lower than the corresponding pixels in the plurality of baseline images 203, the processing unit 102 effectively ensures that the plurality of compensated images 217 maintains the high-intensity characteristics inherent to over-exposed regions. This prevents the generation of unnaturally dim textures in areas that should be characterized by high radiance, thereby facilitating a more accurate and exposure-aligned HDR reconstruction, but the present disclosure is not limited thereto.

According to some embodiments of the present disclosure, the generative model utilized in the first inpainting process, the iterative inpainting process (if performed), and the second inpainting process is a diffusion-based model (e.g., a Latent Diffusion Model or a Denoising Diffusion Probabilistic Model). To preserve the original brightness information and structural consistency during the inpainting, the processing unit 102 employs a stochastic differential equation editing technique (often referred to as SDEdit). Unlike a standard forward diffusion process which adds noise up to a full timestep T (maximum noise level) to completely destroy the original signal, the present method adds noise to the images only up to a partial timestep t, where t<T (e.g., t is within a range of [0.85T, 0.95T] or a specific noise variance level). By stopping at the partial timestep t, the method retains the low-frequency information (such as brightness and global structure) of the input images while allowing the model to generate high-frequency details (textures) during the subsequent denoising process starting from t.

Furthermore, the processing unit 102 may implement a noise scheduling strategy where the target noise level (i.e., the partial timestep t) is configured to decrease across successive inpainting processes. For example, the first inpainting process may utilize a higher target noise level (e.g., t₁=0.95T) to encourage greater generation diversity and creativity in filling large missing regions. As the reconstruction progresses into the iterative refinement or the second inpainting process, the target noise level is reduced (e.g., t₂=0.7T, t₃=0.5T) to limit the degree of modification. This decreasing schedule ensures that later iterations focus on refining local details and maintaining consistency with the previous results, rather than generating entirely new content that might deviate from the physical constraints. This balance between early-stage creativity and late-stage consistency significantly improves the perceptual quality and physical plausibility of the final target HDR image.

In some embodiments, inpainting the over-exposed areas of the plurality of baseline images 203 using the generative model 209 includes conditioning the generative model 209 on prompt information to generate image content for the over-exposed areas in accordance with the luminance constraint. Specifically, the processing unit 102 provides the prompt information, which may include text-based descriptors or semantic labels (e.g., "bright sun," "clear sky," or "interior lighting"), as a conditional input to the generative model 209. According to an embodiment of the present disclosure, the generative model 209 utilizes this prompt information to guide the synthesis of textures and structures that are semantically appropriate for the scene context.

Furthermore, the generative model 209 is configured to incorporate both the prompt information and the luminance constraint during the denoising or generation process to ensure that the synthesized content is not only visually plausible but also photometrically consistent with the high-intensity nature of the saturated regions. For instance, the prompt information may guide the generative model 209 toward producing higher intensity values for pixels identified by the over-exposed area mask 205, thereby facilitating the generation of image content that satisfies the physical requirements of the scene. By conditioning the synthesis on such prompt information, the processing unit 102 achieves a more controlled and accurate reconstruction of the lost details, but the present disclosure is not limited thereto.

In summary, embodiments of the present disclosure provide a generative-based framework for high dynamic range (HDR) reconstruction of over-exposed regions. The disclosed method and system utilize generative priors to synthesize plausible image content while ensuring exposure consistency throughout the reconstruction process. By integrating iterative refinement with luminance compensation mechanisms, embodiments of the present disclosure enables the production of high-quality HDR outputs where synthesized regions are seamlessly blended with original scene data. This framework allows for the restoration of information in regions affected by sensor saturation, providing a versatile solution that can be adapted to various imaging contexts.

Furthermore, the disclosed system and method facilitate significant improvements in visual and photometric accuracy across diverse scenes without necessitating specialized retraining of the underlying generative architectures. By enforcing physical luminance constraints and evaluating luminance discrepancies between different exposure levels, the present disclosure ensures that reconstructed details remain consistent with the original lighting conditions and scene radiance. This approach effectively mitigates artifacts typically associated with unconstrained generative inpainting, thereby providing a robust and scalable solution for high-fidelity HDR restoration. The embodiments described herein are intended to be illustrative rather than restrictive, and the present disclosure is not limited thereto.

While the disclosure has been described by way of example and in terms of the preferred embodiments, it should be understood that the disclosure is not limited to the disclosed embodiments. On the contrary, it is intended to cover various modifications and similar arrangements. Therefore, the scope of the appended claims should be accorded the broadest interpretation so as to encompass all such modifications and similar arrangements.

What is claimed is:

1. A method for HDR reconstruction, comprising:
obtaining an input image;
generating a plurality of baseline images associated with different exposure values (EVs) based on the input image;
identifying a target region in the plurality of baseline images;
performing a first inpainting process on the target region of the plurality of baseline images using a generative model to generate a plurality of inpainted images;
merging the plurality of inpainted images into an HDR image based on a response function;
mapping the HDR image into a plurality of aligned images based on the response function;
performing a compensating step to compensate pixel values of the plurality of aligned images based on the plurality of baseline images, to generate a plurality of compensated images that satisfy a luminance constraint;
performing a second inpainting process on the target region of the plurality of compensated images using the generative model, to generate a plurality of refined images; and
merging the plurality of refined images into a target HDR image.

2. The method as claimed in claim 1, wherein the compensating step further comprises:
determining a luminance difference between the plurality of aligned images and the plurality of baseline images; and
compensating the pixel values of the plurality of aligned images based on the luminance difference to generate the plurality of compensated images.

3. The method as claimed in claim 2, further comprising performing at least one iterative refinement prior to the second inpainting process, wherein the iterative refinement comprises:
performing an iterative inpainting process on the target region of the plurality of compensated images using the generative model to generate an updated plurality of inpainted images;
merging the updated plurality of inpainted images into an updated HDR image based on the response function;
mapping the updated HDR image into an updated plurality of aligned images based on the response function;
calculating an updated luminance difference between the updated plurality of aligned images and the plurality of baseline images; and
generating an updated plurality of compensated images by compensating the pixel values of the updated plurality of aligned images based on the updated luminance difference.

4. The method as claimed in claim 3, wherein identifying the target region comprises generating an over-exposed area mask and a depth map;
wherein the over-exposed area mask is generated based on the input image or a user-provided indication;
wherein the depth map is generated based on the input image; and
wherein the over-exposed area mask indicates over-exposed areas to be processed in the plurality of baseline images;
the method further comprising:
updating the over-exposed area mask based on the updated luminance difference during the iterative refinement, to obtain an updated mask;
wherein the second inpainting process and the iterative inpainting process are performed on the over-exposed areas of the plurality of compensated images based on the depth map and the updated mask.

5. The method as claimed in claim 4, wherein the over-exposed area mask is updated based on the updated luminance difference to exclude regions in which the luminance constraint associated with the over-exposed areas is satisfied.

6. The method as claimed in claim 3, wherein the compensating step further comprises applying a compensation strength that is varied across different performances of the compensating step.

7. The method as claimed in claim 3, wherein the generative model is a diffusion-based model, wherein each of the first inpainting process, the iterative inpainting process, and the second inpainting process comprises adding noise up to a target noise level that is less than a maximum noise level; and
wherein the target noise level is configured to decrease across successive inpainting processes.

8. The method as claimed in claim 1, wherein identifying the target region comprises generating an over-exposed area mask and a depth map;
wherein the over-exposed area mask is generated based on the input image or a user-provided indication;
wherein the depth map is generated based on the input image; and
the over-exposed area mask indicates over-exposed areas to be processed in the plurality of baseline images.

9. The method as claimed in claim 1, wherein the luminance constraint requires that, during the compensating step, luminance values of the plurality of aligned images are not lower than the luminance values of corresponding pixels in the plurality of baseline images.

10. The method as claimed in claim 1, wherein at least one of the first inpainting process or the second inpainting process includes:
conditioning the generative model on prompt information to generate image content for the target region.

11. A system for HDR reconstruction, comprising:
a storage unit, storing computer-executable instructions; and
a processing unit, coupled to the storage unit, wherein upon executing the computer-executable instructions, the processing unit is configured to:
obtain an input image;
generate a plurality of baseline images associated with different exposure values (EVs) based on the input image;
identify a target region in the plurality of baseline images;
perform a first inpainting process on the target region of the plurality of baseline images using a generative model to generate a plurality of inpainted images;
merge the plurality of inpainted images into an HDR image based on a response function;
map the HDR image into a plurality of aligned images based on the response function;
perform a compensating step to compensate pixel values of the plurality of aligned images based on the plurality of baseline images, to generate a plurality of compensated images that satisfy a luminance constraint;
perform a second inpainting process on the target region of the plurality of compensated images using the generative model, to generate a plurality of refined images; and
merge the plurality of refined images into a target HDR image.

12. The system as claimed in claim 11, wherein the processing unit is configured to perform the compensating step by:
determining a luminance difference between the plurality of aligned images and the plurality of baseline images; and
compensating the pixel values of the plurality of aligned images based on the luminance difference to generate the plurality of compensated images.

13. The system as claimed in claim 12, wherein the processing unit is further configured to perform at least one iterative refinement prior to the second inpainting process, wherein the iterative refinement comprises:
performing an iterative inpainting process on the target region using the generative model to generate an updated plurality of inpainted images;
merging the updated plurality of inpainted images into an updated HDR image based on the response function;
mapping the updated HDR image into an updated plurality of aligned images based on the response function;
calculating an updated luminance difference between the updated plurality of aligned images and the plurality of baseline images; and
generating an updated plurality of compensated images by compensating the pixel values of the updated plurality of aligned images based on the updated luminance difference.

14. The system as claimed in claim 13, wherein the processing unit is configured to identify the target region by generating an over-exposed area mask and a depth map;
wherein the over-exposed area mask is generated based on the input image or a user-provided indication;
wherein the depth map is generated based on the input image;
wherein the over-exposed area mask indicates over-exposed areas to be processed in the plurality of baseline images; and
wherein the processing unit is further configured to:
update the over-exposed area mask based on the updated luminance difference during the iterative refinement to obtain an updated mask;
wherein the second inpainting process and the iterative inpainting process are performed on the over-exposed areas of the plurality of compensated images based on the depth map and the updated mask.

15. The system as claimed in claim 14, wherein the over-exposed area mask is updated based on the updated luminance difference to exclude regions in which the luminance constraint associated with the over-exposed areas is satisfied.

16. The system as claimed in claim 13, wherein the processing unit is configured to apply a compensation strength that is varied across different performances of the compensating step when compensating the pixel values of the updated plurality of aligned images.

17. The system as claimed in claim 13, wherein the generative model is a diffusion-based model, and for each of the first inpainting process, the iterative inpainting process, and the second inpainting process, the processing unit is configured to add noise up to a target noise level that is less than a maximum noise level, wherein the target noise level is configured to decrease across successive inpainting processes.

18. The system as claimed in claim 11, wherein the processing unit is configured to identify the target region by generating an over-exposed area mask and a depth map;
wherein the over-exposed area mask is generated based on the input image or a user-provided indication;
wherein the depth map is generated based on the input image; and
the over-exposed area mask indicates over-exposed areas to be processed in the plurality of baseline images.

19. The system as claimed in claim 11, wherein the luminance constraint requires that, during the compensating step, luminance values of the plurality of aligned images are not lower than the luminance values of corresponding pixels in the plurality of baseline images.

20. The system as claimed in claim 11, wherein the processing unit is further configured to condition the generative model on prompt information to generate image content for the target region.
